(19) United States
(12) Patent Application Publication
(10) Pub. No.: US 2026/0067432 A1
(43) Pub. Date: Mar. 5, 2026

(54) ILLUMINATION CONTROL SYSTEM

(71) Applicant: SEIKO EPSON CORPORATION, Tokyo (JP)

(72) Inventors: Fumitaka KATO, MATSUMOTO-SHI (JP); Shinnosuke ARAKI, MATSUMOTO-SHI (JP)

(21) Appl. No.: 19/311,772

(22) Filed: Aug. 27, 2025

(30) Foreign Application Priority Data
Aug. 28, 2024 (JP) 2024-146369

(51) Int. Cl. H04N 9/31

(52) U.S. Cl. CPC H04N 9/3155; H04N 9/3182

(57) ABSTRACT

According to an aspect, there is provided an illumination control system including a projector including a first controller, a first image processor, and a first storage and an illumination device including a second image processor and a light emitter and capable of wirelessly communicating with the projector. The first storage stores image region information, the first controller acquires video data and transmits the acquired video data to the first image processor, the first image processor transmits, to the first controller, gradation data set based on the video data and the image region information stored in the first storage, the first controller transmits the gradation data to the second image processor, and the light emitter emits light based on the gradation data.

The present application is based on, and claims priority from JP Application Serial Number 2024-146369, filed Aug. 28, 2024, the disclosure of which is hereby incorporated by reference herein in its entirety.

### BACKGROUND

### 1. Technical Field

The present disclosure relates to an illumination control system.

### 2. Related Art

JP-A-2013-218153 discloses a configuration of an illumination control system can, by changing a color of illumination light of an illumination device based on parameter values calculated from respective tone values of R, G, and B, cause the illumination device to emit illumination light of a color corresponding to a color of a video projected on a screen. Specifically, a video signal is distributed to a display and the illumination device and a micro processing unit (MPU) determines parameter values of the illumination device.

JP-A-2013-218153 is an example of the related art.

However, the configuration described in JP-A-2013-218153 requires a dedicated device such as an MPU, there is a problem in that the configuration of the illumination control system is complicated.

### SUMMARY

According to an aspect, there is provided an illumination control system including: a display device including a first controller, a first image processor, and a first storage; and an illumination device including a second image processor and a light emitter and capable of wirelessly communicating with the display device, in which the first storage stores image region information, the first controller acquires video data and transmits the acquired video data to the first image processor, the first image processor transmits, to the first controller, gradation data set based on the video data and the image region information stored in the first storage, the first controller transmits the gradation data to the second image processor, and the light emitter emits light based on the gradation data.

### BRIEF DESCRIPTION OF THE DRAWINGS

FIG. 1 is a schematic diagram illustrating a configuration of an illumination control system.

FIG. 2 is a schematic diagram illustrating the configuration of the illumination control system.

FIG. 3 is a block diagram illustrating the configuration of the illumination control system according to a first embodiment.

FIG. 4 is a flowchart illustrating a control method for the illumination control system.

FIG. 5A is a schematic diagram illustrating a part of the control method for the illumination control system.

FIG. 5B is a schematic diagram illustrating a part of the control method for the illumination control system.

FIG. 6 is a flowchart illustrating the control method for the illumination control system.

FIG. 7A is a schematic diagram illustrating a part of the control method for the illumination control system.

FIG. 7B is a schematic diagram illustrating a part of the control method for the illumination control system.

FIG. 7C is a schematic diagram illustrating a part of the control method for the illumination control system.

FIG. 7D is a schematic diagram illustrating a part of the control method for the illumination control system.

FIG. 8 is a block diagram illustrating a configuration of an illumination control system according to a second embodiment.

FIG. 9 is a flowchart illustrating a control method for the illumination control system.

FIG. 10A is a schematic diagram illustrating a part of the control method for the illumination control system.

FIG. 10B is a schematic diagram illustrating a part of the control method for the illumination control system.

FIG. 10C is a schematic diagram illustrating a part of the control method for the illumination control system.

FIG. 10D is a schematic diagram illustrating a part of the control method for the illumination control system.

FIG. 10E is a schematic diagram illustrating a part of the control method for the illumination control system.

### DESCRIPTION OF EMBODIMENTS

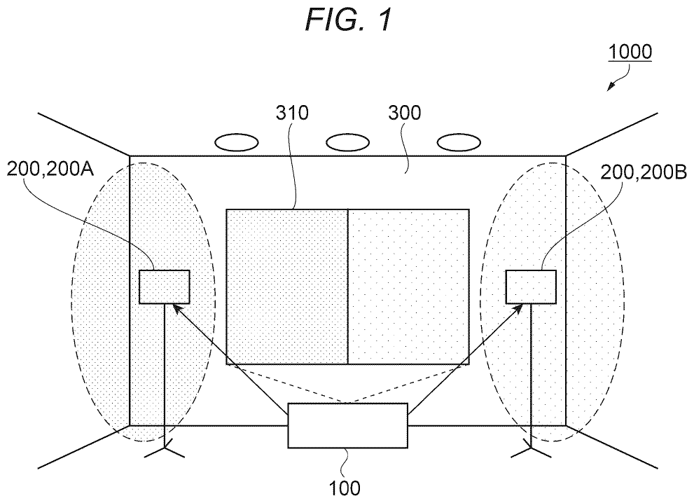

Hereinafter, an illumination control system 1000 and a control method for the illumination control system 1000 are explained with reference to the drawings. First, a configuration of the illumination control system 1000 is explained with reference to FIG. 1.

As illustrated in FIG. 1, the illumination control system 1000 includes a projector 100 serving as a display device and an illumination device 200.

The illumination control system 1000 is, for example, a system capable of further increasing a sense of presence by generally matching a display color of a projection image 310 projected from the projector 100 and a light emission color of the illumination device 200. Note that illumination control system 1000 is not limited to matching the light emission color and may change the light emission color to a different light emission color or may change the light emission color at random.

The projector 100 includes a projection unit 140 for projecting, onto a projection surface 300, image information or the like input from the outside. A projection image 310 based on the image information is displayed on the projection surface 300. Examples of the projection surface 300 include a wall of a room, a screen, and a whiteboard.

The illumination device 200 includes a light emitter 250 that emits light corresponding to the projection image 310. A color, brightness, and the like of the light emitter 250 change based on gradation data. The light emitter 250 includes a light emitting element such as a light emitting diode (LED). For example, the light emitter 250 preferably includes one or a plurality of red LEDs that emit red light, one or a plurality of green LEDs that emit green light, and one or a plurality of blue LEDs that emit blue light. The light emitter 250 is not limited to the LED and may be a light bulb.

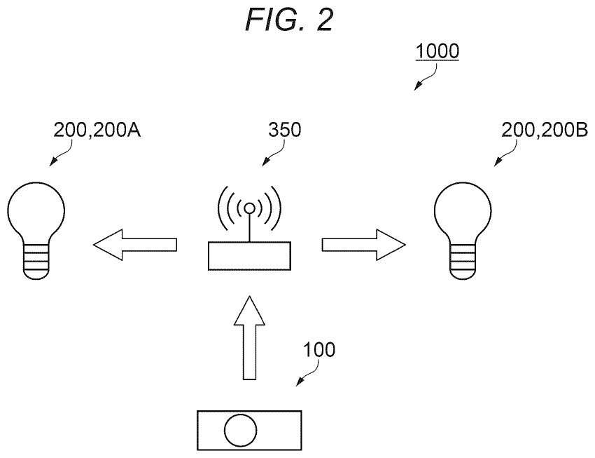

Subsequently, an electric configuration of the illumination control system 1000 is explained with reference to FIG. 2.

As explained above, the illumination control system 1000 includes the projector 100 and the illumination device 200. The illumination device 200 includes, for example, a first illumination device 200A and a second illumination device 200B.

The projector 100 and the two illumination devices 200A and 200B are wirelessly connected via a wireless router 350. The wireless router 350 is, for example, a Wi-Fi (registered trademark) router. The projector 100 and the illumination device 200 are paired by using a Matter's protocol.

The illumination devices 200A and 200B acquire gradation data from the projector 100 to thereby emit light based on the gradation data. The first illumination device 200A emits, for example, based on the gradation data, light of the same color as a color of an image region on the left side in the projection image 310. The second illumination device 200B emits, for example, based on the gradation data, light of the same color as a color of an image region on the right side in the projection image 310 (see FIG. 1).

By configuring the illumination control system 1000 as explained above, it is possible to directly transmit a command from the projector 100 to the illumination devices 200A and 200B and it is possible to reduce a risk of delay.

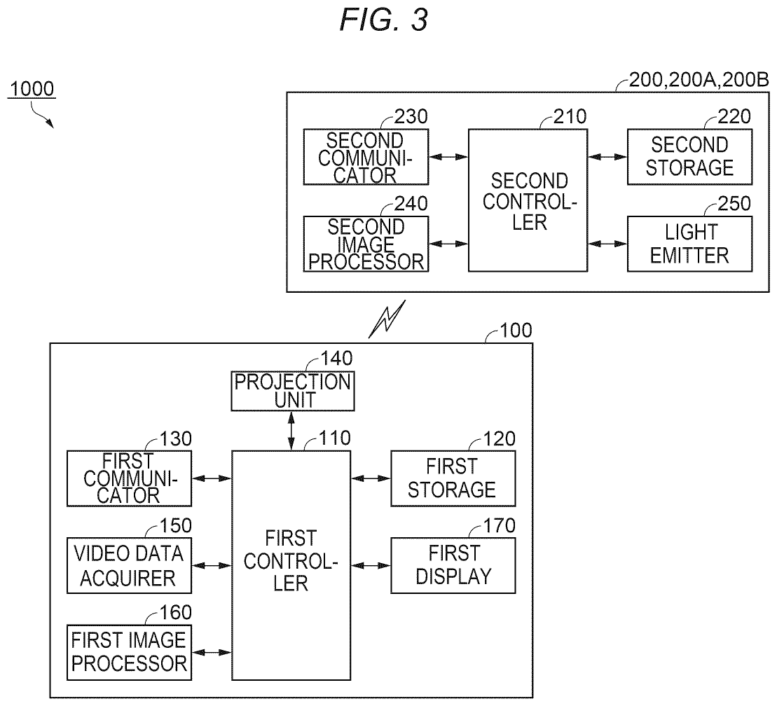

Subsequently, an electric configuration of the illumination control system 1000 in a first embodiment is specifically explained with reference to FIG. 3.

As explained above, the illumination control system 1000 includes the projector 100 and the illumination device 200.

The projector 100 includes a first controller 110, a first storage 120, a first communicator 130, a projection unit 140, a video data acquirer 150, a first image processor 160, and a first display 170.

The first controller 110 includes one or a plurality of processors and operates according to a control program stored in the first storage 120 to thereby integrally control an operation of the projector 100.

The first storage 120 includes memories such as a RAM (Random Access Memory) and a ROM (Read Only Memory). The RAM is used to temporarily store various data and the like and the ROM stores a control program, control data, and the like for controlling the operation of the projector 100. The first storage 120 stores image region information indicating which part of an image region of the entire projection image 310 an image region is.

The first communicator 130 transmits and receives signals to and from the second communicator 230 of the illumination device 200. Specifically, the first communicator 130 transmits and receives signals to and from the second communicator 230 of the first illumination device 200A configuring the illumination device 200 and the second communicator 230 of the second illumination device 200B configuring the illumination device 200.

Although not illustrated, the projection unit 140 includes a light source, a liquid crystal light valve serving as a light modulation device, a projection optical system, and a light valve driver. The projection unit 140 modulates light emitted from the light source with the liquid crystal light valve to form image light, projects the image light from the projection optical system including at least one of a lens and a mirror, and displays the projection image 310 on the projection surface 300.

The video data acquirer 150 acquires video data at predetermined timing among video data input to the projector 100.

The first image processor 160 executes kinds of processing based on an instruction of the first controller 110. The first image processor 160 sets gradation data based on video data transmitted by the first controller 110 and image region information stored in the first storage 120.

The first display 170 includes a display panel such as an LCD (liquid crystal display) and displays, for example, a setting screen of the projector 100.

The illumination device 200 includes a second controller 210, a second storage 220, a second communicator 230, a second image processor 240, and a light emitter 250.

The second controller 210 includes one or a plurality of processors and operates according to a control program stored in the second storage 220 to thereby integrally control an operation of the illumination device 200.

The second storage 220 includes memories such as a RAM (Random Access Memory) and a ROM (Read Only Memory). The RAM is used to temporarily store various data and the like and the ROM stores a control program, control data, and the like for controlling the operation of the illumination device 200.

The second communicator 230 transmits and receives signals to and from the first communicator 130 of the projector 100.

The second image processor 240 executes kinds of processing based on an instruction of the second controller 210. The second image processor 240 converts gradation data transmitted from the projector 100 into light emission data that can be emitted by the light emitter 250.

The light emitter 250 emits light based on gradation data. The light emitter 250 changes brightness or changes a color based on the gradation data. The light emitter 250 includes a light emitting element such as a light emitting diode (LED). For example, the light emitter 250 preferably includes one or a plurality of red LEDs that emit red light, one or a plurality of green LEDs that emit green light, and one or a plurality of blue LEDs that emit blue light.

As explained above, the projector 100 and the illumination device 200 are in a wirelessly communicable state, the gradation data set by the projector 100 is transmitted to the illumination device 200, and the light emitter 250 of the illumination device 200 emits light based on the gradation data. Therefore, it is possible to control the illumination device 200 without using a dedicated device such as an MPU. Thus, the configuration of the illumination control system 1000 can be further simplified compared with when a dedicated device such as an MPU is used.

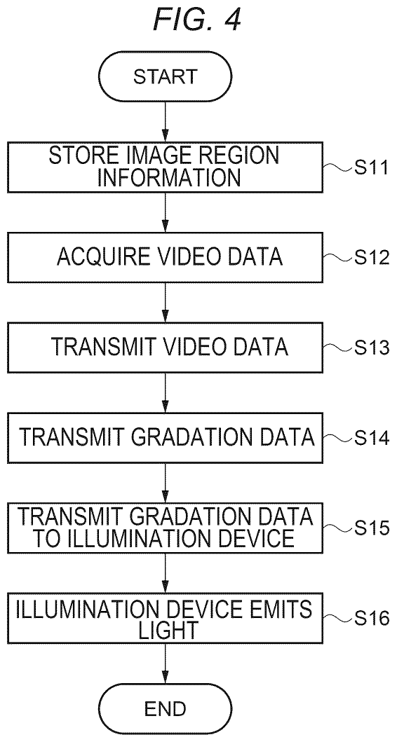

Subsequently, a control method for the illumination control system 1000 is explained with reference to FIGS. 4, 5A, 5B, 6, and 7A to 7D.

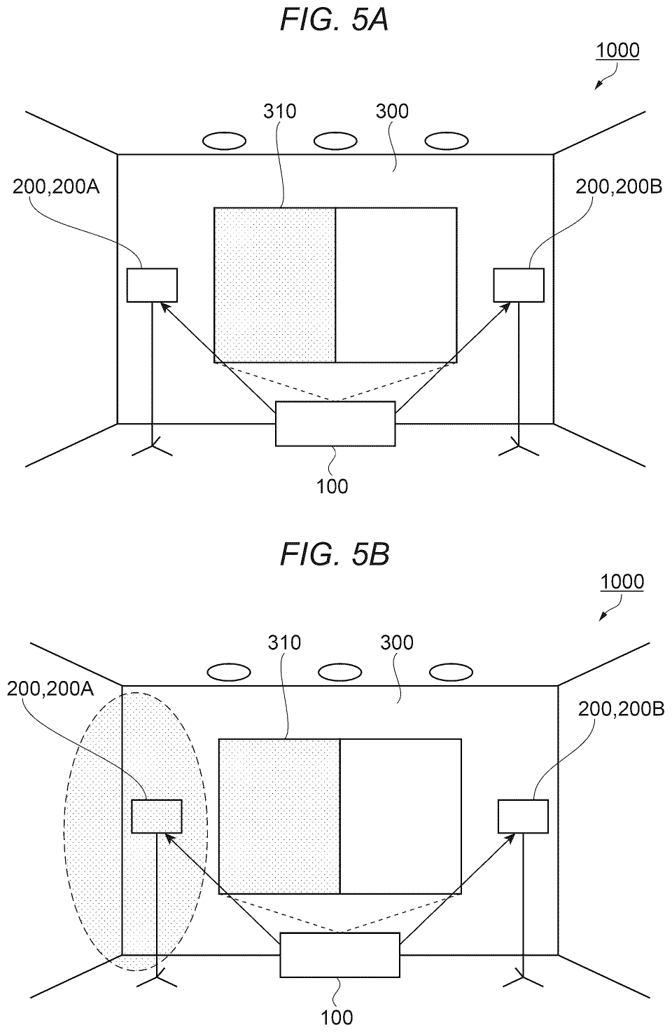

First, a basic control method for the illumination control system 1000 is explained with reference to FIGS. 4, 5A, and 5B. In the control method in the present embodiment, for example, as illustrated in FIG. 1, when a color of an image region on the left side in the projection image 310 is red, a method of causing the first illumination device 200A on the left side to emit light in the same red color is explained.

As illustrated in FIG. 4, in step S11, image region information is stored. Specifically, the first controller 110 of the projector 100 causes the first storage 120 to store image region information indicating that an image region on the left side in the entire projection image 310 is a target (see FIG. 5A).

In step S12, video data is acquired. Specifically, the first controller 110 causes the video data acquirer 150 to acquire video data of the image region on the left side in the projection image 310.

In step S13, the video data is transmitted. Specifically, the first controller 110 transmits the acquired video data to the first image processor 160.

In step S14, gradation data is transmitted. Specifically, the first controller 110 sets gradation data in the first image processor 160 based on the video data and the image region information stored in the first storage 120 and transmits the gradation data.

In step S15, the gradation data is transmitted to the first illumination device 200A. Specifically, the first controller 110 causes the first communicator 130 to transmit the set gradation data to the second communicator 230 of the first illumination device 200A and transmits the gradation data to the second image processor 240.

In step S16, the first illumination device 200A emits light. Specifically, as illustrated in FIG. 5B, the second controller 210 of the first illumination device 200A causes the light emitter 250 to emit light based on the gradation data. For example, when the image region on the left side of the projection image 310 is displayed in red, the light emitter 250 emits light in the same red. Thus, the sense of presence can be increased.

As explained above, the projector 100 and the first illumination device 200A are in the wirelessly communicable state, the gradation data set by the projector 100 is transmitted to the first illumination device 200A, and the light emitter 250 of the first illumination device 200A emits light based on the gradation data, it is possible to control the first illumination device 200A without using a dedicated device such as an MPU. Thus, the configuration of the illumination control system 1000 can be further simplified compared with when a dedicated device such as an MPU is used.

The gradation data is set based on the video data and the image region information in step S14. However, not only this, but the gradation data may be set based on setting information in addition to the video data and the image region information.

Specifically, the setting information is, for example, mode setting. Examples of the mode setting include a theater mode, a sports mode, and a live mode. In the case of the theater mode, for example, the brightness of the first illumination device 200A is set to rather dark. In the case of the sports mode, for example, a frame rate is increased and an update frequency of the gradation data is increased. In the case of the live mode, for example, the brightness of the first illumination device 200A is set to rather bright.

As explained above, since the gradation data is set based on the setting information in addition to the video data and the image region information, for example, a color displayed by the projector 100 and a color of light emitted by the illumination device 200 can be matched and a color, brightness, and the like of the illumination device 200 can be expressed to match the theater mode, the sports mode, and the live mode.

The setting information is not limited to the mode setting and may include setting of an update frequency of gradation data. Since the update frequency of the gradation data is set as explained above, for example, the update frequency of the gradation data can be increased or decreased to be associated with a frame rate as in the sports mode. Accordingly, a spatial presentation effect can be obtained.

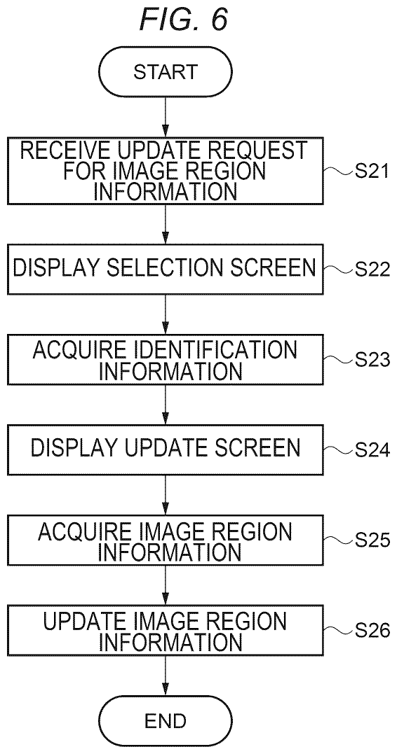

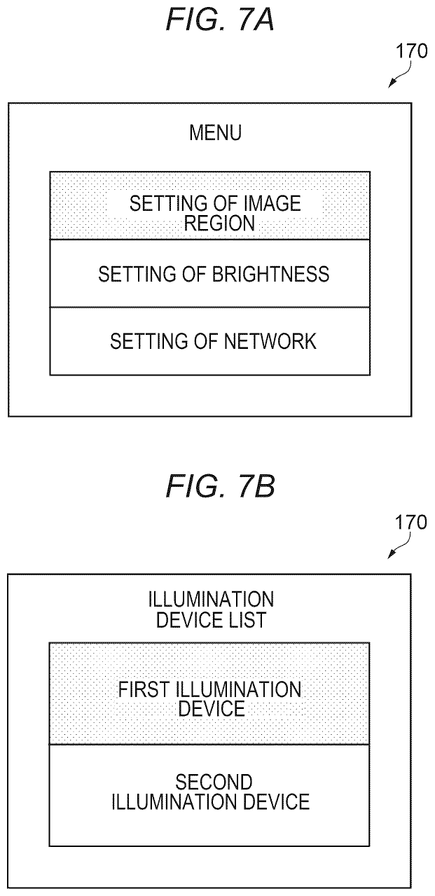

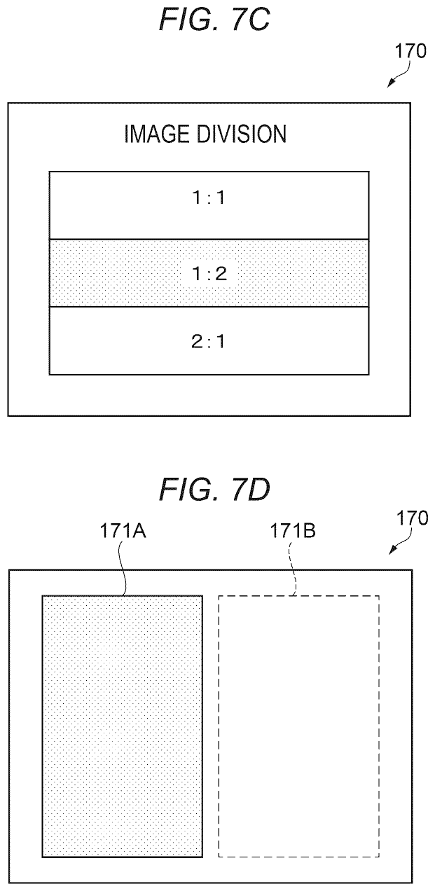

Subsequently, a control method for the illumination control system 1000, for example, a method of controlling the illumination control system 1000 using a user interface (UI) screen is explained with reference to FIGS. 6 and 7A to 7D. In the present embodiment, a method of setting using the first display 170 provided in the projector 100 is explained.

As explained above, the projector 100 is paired with the illumination device 200, which is a Matter device, by using the Matter's protocol. The Matter is one of control protocols. The projector 100 registers the illumination device 200, that is, is paired with the illumination device 200 based on an identification code stored in the first storage 120.

As illustrated in FIG. 6, in step S21, an update request for image region information is received. Specifically, for example, the user touches the first display 170 or presses a selection button.

In step S22, a selection screen is displayed. Specifically, as illustrated in FIG. 7A, the first controller 110 of the projector 100 causes the first display 170 to display a menu, that is, a selection screen. The user selects, for example, “setting of an image region”. Accordingly, the first controller 110 causes the first display 170 to display an “illumination device list” for selecting the illumination device 200.

In step S23, identification information is acquired. Specifically, as illustrated in FIG. 7B, the user selects the first illumination device 200A out of the “illumination device list”. Accordingly, the first controller 110 acquires identification information of the first illumination device 200A.

In step S24, an update screen is displayed. Specifically, the first controller 110 causes the first display 170 to display an update screen for the image region information. First, as illustrated in FIG. 7C, “image division”, that is, a division ratio of the projection image 310 is set. Here, for example, “1:2”, that is, vertical 1 and horizontal 2 are selected. Accordingly, an image region 171A on the left side and an image region 171B on the right side are displayed.

Subsequently, as illustrated in FIG. 7D, whether to set the image region 171A on the left side or the image region 171B on the right side is selected. Here, for example, the image region 171A on the left side is selected. That is, image region information is determined. In other words, a display color of a region on the left side in the projection image 310 projected from the projector 100 and a light emission color of the first illumination device 200A are set the same.

In step S25, the image region information is acquired. In step S26, the image region information is updated. Specifically, the first controller 110 acquires the image region information, causes the first storage 120 to store the image region information, and updates the information.

Thereafter, by performing processing in the same manner as in steps S12 to S16 explained above, the first illumination device 200A emits light as illustrated in FIG. 5B. For example, when the image region on the left side of the projection image 310 is displayed in red, the light emitter 250 emits light in the same red. Thus, the sense of presence can be increased. When the second illumination device 200B is caused to emit light in the same color as the image region on the right side of the projection image 310 (see FIG. 1), the projector 100 and the second illuminator 200B are set in the same manner as the method explained above.

As explained above, since the gradation data is set using the first display 170 of the projector 100, the color of the illumination device 200 can be set only by operating the projector 100 without using a device other than the projector 100 and the illumination device 200.

As explained above, the illumination control system 1000 according to the first embodiment is the illumination control system 1000 including the projector 100 including the first controller 110, the first image processor 160, and the first storage 120 and the illumination device 200 including the second image processor 240 and the light emitter 250 and capable of wirelessly communicating with the projector. The first storage 120 stores the image region information, the first controller 110 acquires the video data and transmits the acquired video data to the first image processor 160, the first image processor 160 transmits, to the first controller 110, the gradation data set based on the video data and the image region information stored in the first storage 120, the first controller 110 transmits the gradation data to the second image processor 240, and the light emitter 250 emits light based on the gradation data.

With this configuration, since the projector 100 and the illumination device 200 are in the wirelessly communicable state, the gradation data set by the projector 100 is transmitted to the illumination device 200, and the light emitter 250 of the illumination device 200 emits light based on the gradation data, for example, it is possible to control the illumination device 200 without using a dedicated device such as an MPU. Thus, the configuration of the illumination control system 1000 can be further simplified compared with when a dedicated device such as an MPU is used.

The projection image 310 projected by the projector 100 and a color of the illumination device 200 can be linked and the spatial presentation effect can be increased. Furthermore, besides the projection image 310, a surrounding wall can also be shone by the illumination device 200 and video experience can be expanded. Further, since a color of the projection image 310 is determined from video data input to the projector 100, it is possible to cope with any video source, for example, a streaming video or terrestrial digital broadcasting. Since the MPU of the related art does not acquire information concerning the projector 100, the MPU cannot adjust a tone value of the projector 100 according to color conversion setting of the projector 100.

In the illumination control system 1000 in the first embodiment, it is preferable that the first storage 120 stores setting information and the first image processor 160 sets gradation data based on video data, image region information, and setting information. With this configuration, since the gradation data is set based on the setting information in addition to the video data and the image region information, for example, a color displayed by the projector 100 and a color of light emitted by the illumination device 200 can be matched.

In the illumination control system 1000 in the first embodiment, it is preferable that the setting information is information concerning mode setting provided in the projector 100. With this configuration, since the setting information is information concerning the mode setting, for example, it is possible to express a color, brightness, and the like of the illumination device 200 to match the theater mode, the sports mode, and the live mode.

In the illumination control system 1000 in the first embodiment, it is preferable that the first controller 110 sets an update frequency of gradation data based on the setting information. With this configuration, since the update frequency of the gradation data is set based on the setting information, for example, it is possible to increase or reduce the update frequency of the gradation data to be associated with a video frame rate. Accordingly, a spatial presentation effect can be obtained.

In the illumination control system 1000 in the first embodiment, it is preferable that the projector 100 includes the first display 170 and receives an update request for the image region information, the first display 170 displays a selection screen for selecting the illumination device 200, the projector 100 acquires identification information of the illumination device 200 selected by the user, the first display 170 displays an update screen for the image region information, and the projector 100 acquires image region information selected by the user and updates the image region information based on the identification information of the illumination device 200 selected by the user and the image region information selected by the user. With this configuration, since the image region for obtaining the gradation data is set using the projector 100, the user can adjust a color of the illumination device 200 by operating only the projector 100 without using another device.

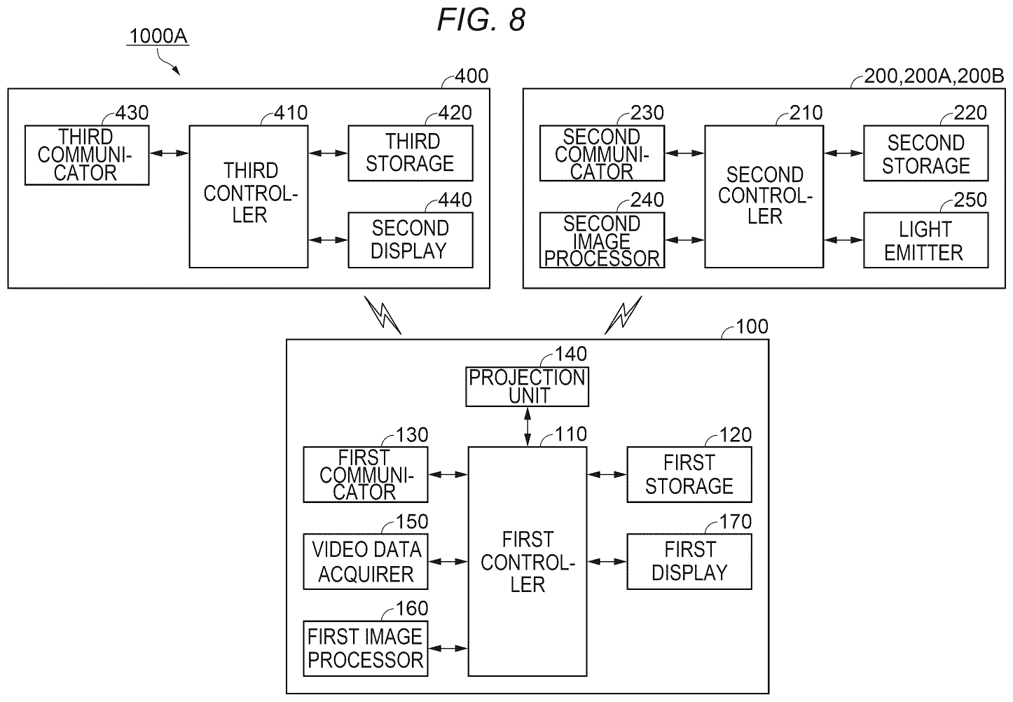

Subsequently, an electric configuration of an illumination control system 1000A in a second embodiment is explained with reference to FIG. 8.

The illumination control system 1000A in the second embodiment is different from the illumination control system 1000 in the first embodiment in that the illumination control system 1000A includes a smartphone 400 as an information processing device. For this reason, in the second embodiment, portions different from those in the first embodiment are explained in detail and redundant explanation is omitted as appropriate about the other portions.

As illustrated in FIG. 8, an illumination control system 1000A in the second embodiment includes the projector 100, the illumination device 200, and the smartphone 400 serving as the information processing device. The smartphone 400 is connected to the projector 100 by radio.

As in the first embodiment, the projector 100 includes the first controller 110, the first storage 120, the first communicator 130, the projection unit 140, the video data acquirer 150, the first image processor 160, and the first display 170.

As in the first embodiment, the illumination device 200 includes the second controller 210, the second storage 220, the second communicator 230, the second image processor 240, and the light emitter 250.

The smartphone 400 includes a third controller 410, a third storage 420, a third communicator 430, and a second display 440.

The third controller 410 includes one or a plurality of processors and operates according to a control program stored in the third storage 420 to thereby integrally control an operation of the smartphone 400.

The third storage 420 includes memories such as a RAM (Random Access Memory) and a ROM (Read Only Memory). The RAM is used to temporarily store various data and the like and the ROM stores a control program, control data, and the like for controlling the operation of the smartphone 400. The third storage 420 stores image region information indicating which part of an image region of the entire projection image 310 an image region is.

The third communicator 430 transmits and receives signals to and from the first communicator 130 of the projector 100.

The second display 440 includes a display panel such as a liquid crystal display (LCD) and displays a selection screen for selecting the illumination device 200, an update screen for the image region information, and the like.

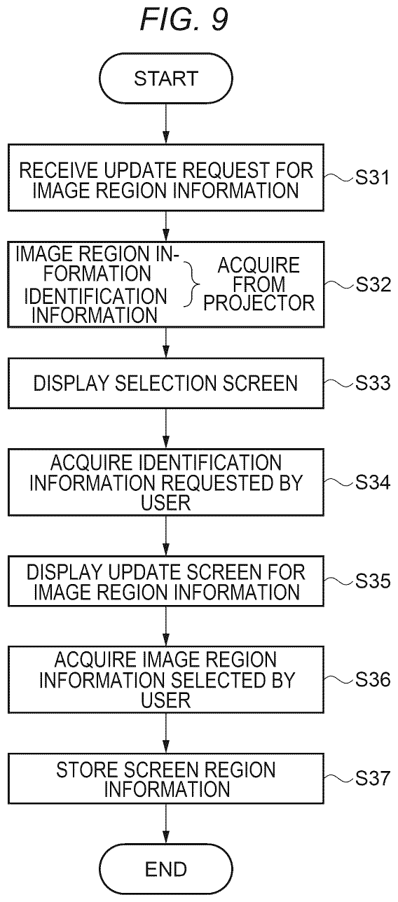

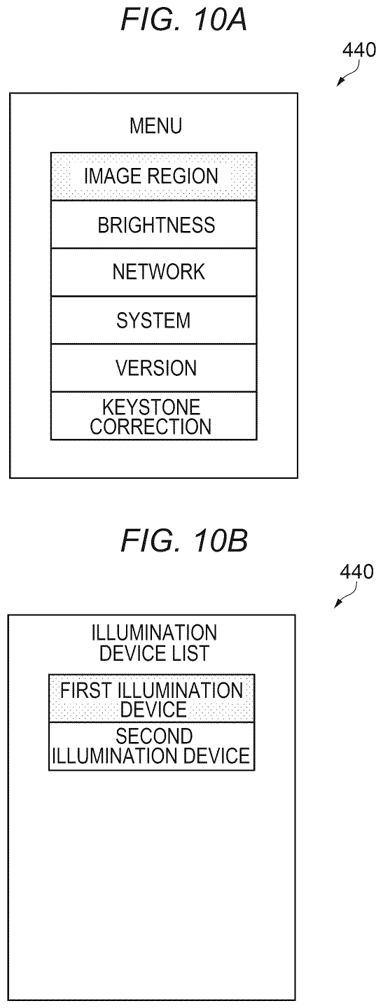

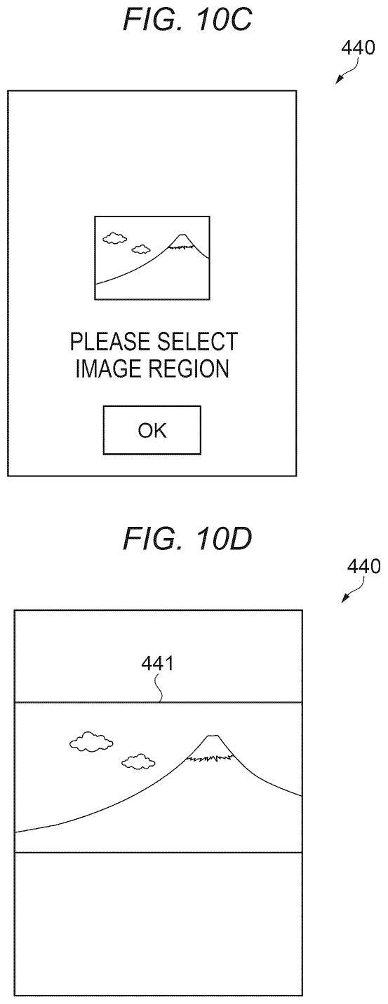

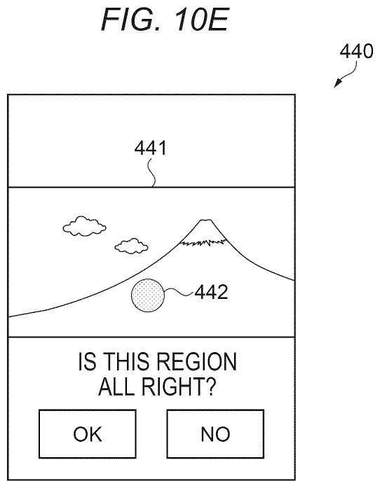

Subsequently, a control method for the illumination control system 1000A in the second embodiment, for example, a method of controlling the illumination control system 1000A using a user interface (UI) screen is explained with reference to FIGS. 9 and 10A to 10E. In the present embodiment, a method of setting using the second display 440 provided in the smartphone 400 is explained. The projector 100 and the smartphone 400 are paired.

As illustrated in FIG. 9, in a step S31, an update request for image region information is accepted. Specifically, for example, a user touches the second display 440 of the smartphone 400.

In step S32, image region information and identification information are acquired from the projector 100. Specifically, when the user touches the second display 440, the third controller 410 of the smartphone 400 causes the third communicator 430 to transmits a request to the first communicator 130 of the projector 100 to acquire image region information and identification information stored in the first storage 120 of the projector 100. Accordingly, the third controller 410 acquires the image region information and the identification information from the projector 100.

In step S33, a selection screen is displayed. Specifically, the third controller 410 of the smartphone 400 causes the second display 440 to display a menu screen (see FIG. 10A). The user selects “image region” out of a menu.

In step S34, the identification information requested by the user is acquired. Specifically, since the image region is selected, the third controller 410 of the smartphone 400 causes the second display 440 to display an illumination device list for selecting the illumination device 200 (see FIG. 10B). For example, the first illumination device 200A and the second illumination device 200B are displayed on the second display 440. For example, the user selects the first illumination device 200A out of the illumination device list. The third controller 410 acquires identification information of the first illumination device 200A.

In step S35, an update screen of the image region information is displayed. Specifically, the third controller 410 of the smartphone 400 causes the second display 440 to display an update screen for the image region information acquired from the projector 100 in step S32 (see FIG. 10C). The user presses an “OK” button displayed under “Please select an image region”. Accordingly, an image 441 in which information concerning an aspect ratio of the projection image 310 is reflected is displayed on the second display 440 (see FIG. 10D).

In step S36, the image region information selected by the user is acquired. Specifically, the user touches, in the displayed image 441, a portion 442 of a color of light that the user desires to cause the first illumination device 200A to emit (see FIG. 10E). The third controller 410 acquires the image region information selected by the user.

In step S37, the image region information is stored. Specifically, the first controller 110 of the projector 100 stores, in the first storage 120, the image region information updated based on the identification information of the first illumination device 200A selected by the user and the image region information selected by the user.

Thereafter, by performing processing in the same manner as in steps S12 to S16 explained above, as illustrated in FIG. 5B, the first illumination device 200A emits light corresponding to a color of a set image region. When the second illumination device 200B is caused to emit light in the same color as the image region on the right side of the projection image 310 (see FIG. 1), the projector 100 and the second illuminator 200B are set in the same manner as the method explained above.

As explained above, since the image region information for obtaining the gradation data is set using the smartphone 400, the user can adjust the color of the illumination device 200 by operating only the smartphone 400 without using another device.

Further, since the smartphone 400 acquires information concerning an aspect ratio of display image, that is, the projection image 310 from the projector 100, it is possible to prevent a tone value of a portion to be a black image in the projection image 310 from being reflected in the gradation data. Since the display image is acquired and the update screen for the image region information is generated, it is easy for the user to understand which color of the video data the user desires to acquire.

As explained above, the illumination control system 1000A in the second embodiment includes the smartphone 400 including the third controller 410, the third storage 420, and the second display 440 and capable of wirelessly communicating with the projector 100, the smartphone 400 receives the update request for the image region information and acquires the image region information and the identification information of the illumination device 200 from the projector 100, the second display 440 displays the selection screen for selecting the illumination device 200, the smartphone 400 acquires the identification information of the illumination device 200 selected by the user, the second display 440 displays the update screen for the image region information, the smartphone 400 acquires the image region information selected by the user, and the projector 100 stores the image region information updated based on the identification information of the illumination device 200 selected by the user and the image region information selected by the user.

With this configuration, since the image region of the video data for obtaining the gradation data is set using the smartphone 400, the user can adjust the color of the illumination device 200 by operating only the smartphone 400 without using another device.

In the illumination control system 1000A in the second embodiment, it is preferable that the smartphone 400 acquires the image region information, the identification information of the illumination device 200, and the information concerning the aspect ratio of the display image from the projector 100 and the second display 440 displays the update screen for the image region information based on the information concerning the aspect ratio of the display image. With this configuration, since the information concerning the aspect ratio of the display image of the projector 100 is acquired, it is possible to prevent a portion to be a black image in the display image from being reflected in the gradation data.

In the illumination control system 1000A in the second embodiment, it is preferable that the smartphone 400 acquires the image region information, the identification information of the illumination device 200, and the display image from the projector 100 and the second display 440 displays the update screen for the image region information based on the display image. With this configuration, since the display image is acquired and the update screen for the image region information is generated, it is easy for the user to understand which color of the video data the user desires to acquire.

Modifications of the embodiments explained above is explained below.

As explained above, the color of the light to be emitted by the illumination device 200 is set from the acquired video data. However, not only this, but, for example, the color of the light to be emitted by the illumination device 200 may be set from acquired sound data. Environmental sound may be acquired from a microphone incorporated in the projector 100 or the smartphone 400 and reflected in the color of the illumination device 200. The brightness of the illumination device 200 may be changed based on a brightness level of the projector 100.

As explained above, the control protocol is not limited to using the Matter, a common standard is acceptable, and a control protocol other than the Matter may be used.

A summary of the present disclosure is appended below.

(Appendix 1) An illumination control system including: a display device including a first controller, a first image processor, and a first storage; and an illumination device including a second image processor and a light emitter and capable of wirelessly communicating with the display device, in which the first storage stores image region information, the first controller acquires video data and transmits the acquired video data to the first image processor, the first image processor transmits, to the first controller, gradation data set based on the video data and the image region information stored in the first storage, the first controller transmits the gradation data to the second image processor, and the light emitter emits light based on the gradation data.

With this configuration, since the display device and the illumination device are in the wirelessly communicable state, the gradation data set in the display device is transmitted to the illumination device, and the light emitter of the illumination device emits light based on the gradation data, for example, it is possible to control the illumination device without using a dedicated device such as an MPU. Therefore, the configuration of the illumination control system can be simplified compared with when a dedicated device such as an MPU is used.

(Appendix 2) The illumination control system described in Appendix 1, in which the first storage stores setting information, and the first image processor sets the gradation data based on the video data, the image region information, and the setting information. With this configuration, since the gradation data is set based on the setting information in addition to the video data and the image region information, for example, it is possible to match a color displayed by the display device and a color of light emitted by the illumination device.

(Appendix 3) The illumination control system described in Appendix 2, in which the setting information is information concerning mode setting provided in the display device. With this configuration, since the setting information is the information concerning the mode setting, for example, it is possible to express a color, brightness, and the like of the illumination device can be expressed to match a theater mode, a sports mode, and a live mode.

(Appendix 4) The illumination control system described in Appendix 2 or 3, in which the first controller sets an update frequency of the gradation data based on the setting information. With this configuration, since the update frequency of the gradation data is set based on the setting information, for example, it is possible to increase or reduce the update frequency of the gradation data to be associated with a video frame rate. Accordingly, a spatial presentation effect can be obtained.

(Appendix 5) The illumination control system according to any one of Appendixes 1 to 4, in which the display device includes a first display and receives an update request for the image region information, the first display displays a selection screen for selecting the illumination device, the display device acquires identification information of the illumination device selected by a user, the first display displays an update screen for the image region information, and the display device acquires image region information selected by the user and updates the image region information based on the identification information of the illumination device selected by the user and the image region information selected by the user. With this configuration, since the image region for acquiring the gradation data is set using the display device, the user can adjust a color of the illumination device by operating only the display device without using another device.

(Appendix 6) The illumination control system according to any one of Appendixes 1 to 5, further including an information processing device including a third controller, a third storage, and a second display and capable of wirelessly communicating with the display device, in which the information processing device receives an update request for the image region information and acquires the image region information and identification information of the illumination device from the display device, the second display displays a selection screen for selecting the illumination device, the information processing device acquires identification information of the illumination device selected by a user, the second display displays an update screen for the image region information, the information processing device acquires image region information selected by the user, and the display device stores the image region information updated based on the identification information of the illumination device selected by the user and the image region information selected by the user. With this configuration, since the image region of the video data for acquiring the gradation data is set using the information processing device, the user can adjust a color of the illumination device by operating only the information processing device without using another device.

(Appendix 7) The illumination control system described in Appendix 6, in which the information processing device acquires the image region information, the identification information of the illumination device, and information concerning an aspect ratio of a display image from the display device, and the second display displays the update screen for the image region information based on the information concerning the aspect ratio of the display image. With this configuration, since the information concerning the aspect ratio of the display image of the display device is acquired, it is possible to prevent a tone value of a portion to be a black image in the display image from being reflected in the gradation data.

(Appendix 8) The illumination control system described in Appendix 6 or 7, in which the information processing device acquires the image region information, the identification information of the illumination device, and a display image from the display device, and the second display displays the update screen for the image region information based on the display image. With this configuration, since the display image is acquired and the update screen for the image region information is generated, it is easy for the user to understand which color of the video data the user desires to acquire.

What is claimed is:

1. An illumination control system comprising:
a display device including a first controller, a first image processor, and a first storage; and
an illumination device including a second image processor and a light emitter and capable of wirelessly communicating with the display device, wherein
the first storage stores image region information,
the first controller acquires video data and transmits the acquired video data to the first image processor,
the first image processor transmits, to the first controller, gradation data set based on the video data and the image region information stored in the first storage,
the first controller transmits the gradation data to the second image processor, and
the light emitter emits light based on the gradation data.

2. The illumination control system according to claim 1, wherein
the first storage stores setting information, and
the first image processor sets the gradation data based on the video data, the image region information, and the setting information.

3. The illumination control system according to claim 2, wherein the setting information is information concerning mode setting provided in the display device.

4. The illumination control system according to claim 3, wherein the first controller sets an update frequency of the gradation data based on the setting information.

5. The illumination control system according to claim 1, wherein
the display device includes a first display and receives an update request for the image region information,
the first display displays a selection screen for selecting the illumination device,
the display device acquires identification information of the illumination device selected by a user,
the first display displays an update screen for the image region information, and
the display device acquires image region information selected by the user and updates the image region information based on the identification information of the illumination device selected by the user and the image region information selected by the user.

6. The illumination control system according to claim 1, further comprising an information processing device including a third controller, a third storage, and a second display and capable of wirelessly communicating with the display device, wherein
the information processing device receives an update request for the image region information and acquires the image region information and identification information of the illumination device from the display device,
the second display displays a selection screen for selecting the illumination device,
the information processing device acquires identification information of the illumination device selected by a user,
the second display displays an update screen for the image region information,
the information processing device acquires image region information selected by the user, and
the display device stores the image region information updated based on the identification information of the illumination device selected by the user and the image region information selected by the user.

7. The illumination control system according to claim 6, wherein
the information processing device acquires the image region information, the identification information of the illumination device, and information concerning an aspect ratio of a display image from the display device, and
the second display displays the update screen for the image region information based on the information concerning the aspect ratio of the display image.

8. The illumination control system according to claim 6, wherein
the information processing device acquires the image region information, the identification information of the illumination device, and a display image from the display device, and
the second display displays the update screen for the image region information based on the display image.
